(19) United States
(12) Patent Application Publication
(10) Pub. No.: US 2006/0013489 A1
(43) Pub. Date: Jan. 19, 2006

(54) Methods of representing a color with a compressed code

(76) Inventors: Robert R. Pospischil, Nesconset, NY (US); John H. Tilton, Oyster Bay, NY (US); James C. Kish, Las Vegas, NV (US)

Correspondence Address: Galgano & Burke, Suite 135, 300 Rabro Drive, Hauppauge, NY, 11788, US

(21) Appl. No.: 10/892,573

(22) Filed: Jul. 16, 2004

(51) Int. Cl. G06K 9/36

(52) U.S. Cl. 382/232

(57) ABSTRACT

The methods according to the invention include converting the three digit decimal red, green, and blue values (000-255) to two digit decimal values (00-25), representing each two digit decimal value as an alpha character, and encoding the alpha character using the standard UPC alpha character codes. A rounding algorithm is provided for rounding up the least significant digit in different ways depending on the range of the value when encoding and decoding. The methods of the invention may be used to express RGB values as three alpha characters rather than as 24-bits (8-bit R, 8-bit G, and 8-bit B) in applications other than bar coding.

### BACKGROUND OF THE INVENTION

1. Field of the Invention

The invention relates to encoding of information. More particularly, the invention relates to encoding information about a color in a compressed manner.

2. Brief Description of the Prior Art

The RGB color coding system is based on 256 levels of red, green and blue, respectively. This yields 1.677722×10⁷ (256×256×256) different colors, a number sufficient to render photo quality images.

The UPC barcode system and other systems like it have several well defined fields, each capable of representing a seven digit binary numeral (i.e. from 0-127 in decimal notation). The well defined fields identify the product and the manufacturer and other information such as coupon codes, pharmaceutical identification, and uncertain weight identification. In addition to the well defined fields, the UPC system provides for an additional five fields to be utilized for encoding additional information. Prior art FIG. 1 illustrates a barcode, which includes these additional five fields, shown as 52000 in the Figure.

Many products are sold in different colors and there is no standardized way of identifying the color of a product in the UPC barcode. Sixty percent of consumer product selection is based on color. It would be desirable to provide a uniform method of indicating product color in a UPC barcode.

The present invention is based on the observation that it would be desirable to represent an RGB color code in the five extra fields of a UPC barcode. Those skilled in the art will appreciate, however, that the RGB code requires three fields, each having a value of 0-255 (eight bits), whereas the UPC fields can only represent values from 0-127 (seven bits).

### SUMMARY OF THE INVENTION

It is therefore an object of the invention to provide a method of encoding an RGB color identification in a UPC barcode.

It is also an object of the invention to provide a method of encoding an RGB color identification using fewer than eight bits for each of the three components.

It is another object of the invention to provide a method for decoding RGB information in a UPC barcode.

In accord with these objects which will be discussed in detail below, the methods according to the invention include converting the three digit decimal red, green, and blue values (000-255, eight bits) to two digit decimal values (00-25, which can be expressed in five bits), representing each two digit decimal value as an alpha character, and encoding the alpha character using the standard UPC alpha character codes. A rounding algorithm is provided for rounding up the least significant digit in different ways depending on the range of the value when encoding and decoding. The methods of the invention may be used to express RGB values as three alpha characters rather than as 24-bits (8-bit R, 8-bit G, and 8-bit B) in applications other than bar coding.

The methods of the invention provide the ability to encode over 17,000 different colors with just three alpha characters. This gives consumers the ability to color coordinate products that match or compliment each other. The methods of the invention also permit the cross referencing of colors of products from different sources. The methods provide manufacturers with the ability to accurately indicate product color in a portion of a barcode or with three letters. Three letter color codes according to the invention are easy for the consumer to read and match. The methods also permit the matching of identical colors where the manufacturers use different names for the same color.

### BRIEF DESCRIPTION OF THE DRAWINGS

FIG. 1 is an illustration of a prior art barcode having five optional fields;

FIG. 2 is a high level flow chart illustrating encoding of a barcode according to a first embodiment of the invention;

FIG. 3 is a high level flow chart illustrating decoding of a barcode according to the first embodiment of the invention;

FIG. 4 is a high level flow chart illustrating encoding of a barcode according to a second embodiment of the invention; and

FIG. 5 is a high level flow chart illustrating decoding of a barcode according to the second embodiment of the invention.

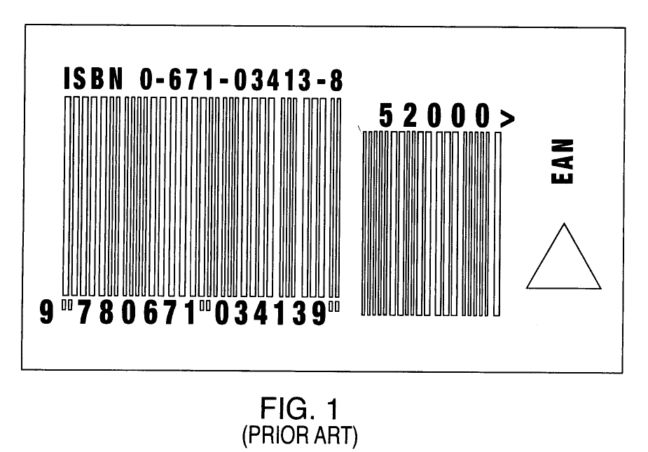

### DETAILED DESCRIPTION

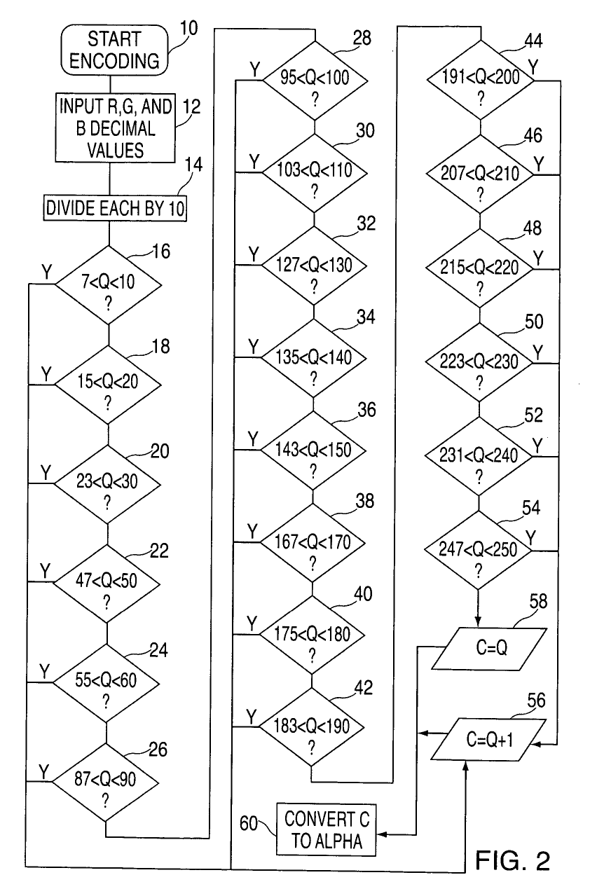

Turning now to FIG. 2, an encoding method according to the invention begins at 10. Each Red, Green, and Blue value is input in decimal form at 12, yielding a number between 0-255 (eight bits) for each of the Red, Green, and Blue values. The remaining steps in FIG. 2 are performed for each value input at 12. Each value is divided by ten at 14, thus yielding an integer between 0-25 (can be expressed in five bits). According to the illustrated method in FIG. 2, the quotient Q from each division is rounded to an integer and then additionally rounded up by one if Q falls within any one of several preset ranges. These ranges are illustrated at comparison steps 16 through 54. If Q falls within any one of these ranges, it is rounded up by one at 56 to yield a color value C. If Q does not fall within any of these ranges, it is not altered and C is set equal to Q at 58. Once C has been calculated, it is converted to an alpha code at 60 and then encoded into three predetermined fields of the optional five fields in a UPC barcode. As mentioned above, the alpha values are assigned A=0, B=1, C=2, . . . , Z=25.

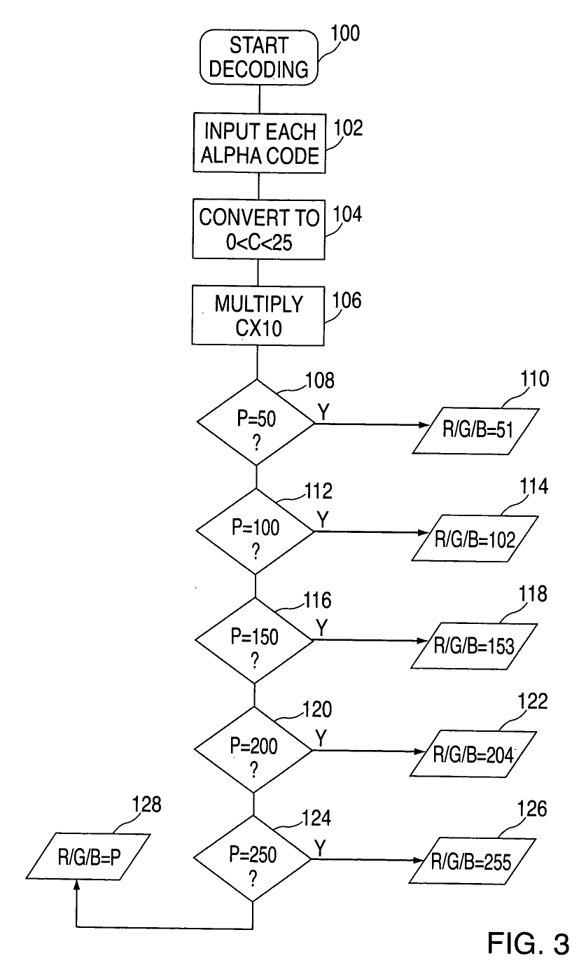

FIG. 3 illustrates how RGB values are decoded from a UPC barcode starting at 100. The three alpha values are read from the barcode at 102. The letters are converted into C values between 0-25 at 104. Each C value is multiplied by ten at 106 to yield a P value which is rounded up under certain conditions. For example, if it is determined at 108 that P=50, it is rounded up at 110 to 51 which is then used as the R/G/B value. If it is determined at 112 that P=100, it is rounded up at 114 to 102 which is then used as the R/G/B value. If it is determined at 116 that P=150, it is rounded up at 118 to 153 which is then used as the R/G/B value. If it is determined at 120 that P=200, it is rounded up at 122 to 204 which is then used as the R/G/B value. If it is determined at 124 that P=250, it is rounded up at 126 to 255 which is then used as the R/G/B value. If P does not equal any of the values tested, it is not changed and is used as the R/G/B value at 128.

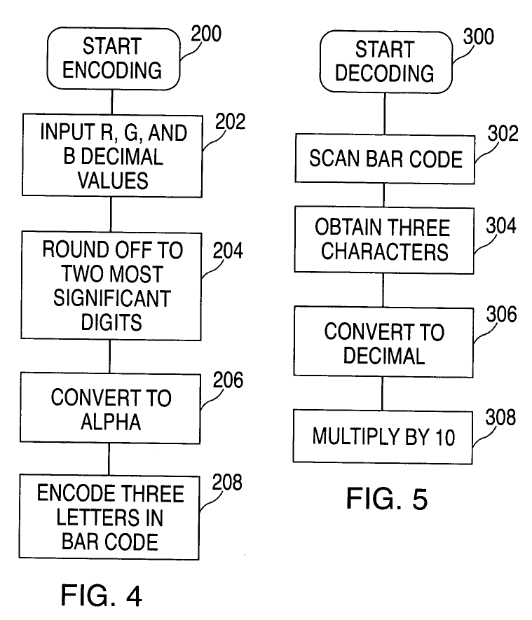

A simplified method of encoding and decoding is illustrates in FIGS. 4 and 5. Encoding begins at 200. Red, green, and blue values are input as three digit decimal numbers at 202. The numbers are rounded off to their two most significant digits at 204. For example, 216 would be rounded off to 22. The value 255, however, is truncated to 25. The two digit numbers, which range from 0-25, are converted to an alpha character at 206 and the three alpha characters are encoded in a barcode at 208.

Decoding begins at 300. The barcode is scanned at 302. The three alpha characters are obtained at 304. The alpha characters are converted to decimal numbers at 306. RGB values are obtained at 308 by adding a zero to each of the decimal numbers.

The methods of the invention take a 24-bit RGB value and convert it into three alpha characters (three numbers between 0-25) which are then used to encode optional fields in a barcode. It will be appreciated however, that the compressed RGB value may be used in other applications. The methods of the invention also include taking a compressed RGB value and expanding it back to a 24-bit RGB value.

There have been described and illustrated herein methods for representing a color in a compressed code. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as so claimed.

What is claimed is:

1. A method for compressing 24-bit RGB color information, comprising:
reducing the eight bit red number to a five bit red number through division;
rounding the five bit red number up by one if it is within one of a plurality of predetermined ranges;
reducing the eight bit green number to a five bit green number through division;
rounding the five bit green number up by one if it is within one of a plurality of predetermined ranges;
reducing the eight bit blue number to a five bit blue number through division; and
rounding the five bit blue number up by one if it is within one of a plurality of predetermined ranges.

2. The method according to claim 1, wherein:
said plurality of predetermined ranges include twenty ranges.

3. The method according to claim 2, wherein said ranges, expressed as decimal numbers, are:
greater than 7 but less than 10,
greater than 15 but less than 20,
greater than 23 but less than 30,
greater than 47 but less than 50,
greater than 55 but less than 60,
greater than 87 but less than 90,
greater than 95 but less than 100,
greater than 103 but less than 110,
greater than 127 but less than 130,
greater than 135 but less than 140,
greater than 143 but less than 150,
greater than 167 but less than 170,
greater than 175 but less than 180,
greater than 183 but less than 190,
greater than 191 but less than 200,
greater than 207 but less than 210,
greater than 215 but less than 220,
greater than 223 but less than 230,
greater than 231 but less than 240, and
greater than 247 but less than 250.

4. The method according to claim 1, further comprising:
converting each of the five bit numbers into an alpha value.

5. The method according to claim 4, further comprising:
encoding each alpha value into a field of a barcode.

6. A method for generating a 24-bit RGB value from a 15-bit compressed RGB value:
expanding the five bit red number to an eight bit red number through multiplication;
rounding the eight bit red number by a value of one or more if it is one of a plurality of predetermined values;
expanding the five bit green number to an eight bit green number through multiplication;
rounding the eight bit green number by a value of one or more if it is one of a plurality of predetermined values;
expanding the five bit blue number to an eight bit blue number through multiplication; and
rounding the eight bit blue number by a value of one or more if it is one of a plurality of predetermined values.

7. The method according to claim 6, wherein:
said plurality of predetermined values include five values.

8. The method according to claim 7, wherein:
said predetermined values are 50, 100, 150, 200, and 250.

9. The method according to claim 8, wherein:
said rounding is +1 when said predetermined value is 50;
said rounding is +2 when said predetermined value is 100;
said rounding is +3 when said predetermined value is 150;
said rounding is +4 when said predetermined value is 200; and
said rounding is +5 when said predetermined value is 250.

10. The method according to claim 6, wherein:
each of the five bit numbers are derived from alpha values.

11. The method according to claim 10, wherein:
each of the alpha values are derived from a barcode.

12. A method for compressing RGB color information, comprising:
reducing the three digit red number to a two digit red number through division;
rounding the two digit red number up by one if division results in a remainder of five or more;
converting the two digit red number to a single alpha character;
reducing the three digit green number to a two digit green number through division;
rounding the two digit green number up by one if division results in a remainder of five or more;
converting the two digit green number to a single alpha character;
reducing the three digit blue number to a two digit blue number through division;
rounding the two digit blue number up by one if division results in a remainder of five or more; and
converting the two digit blue number to a single alpha character.

13. The method according to claim 12, further comprising:
encoding the alpha characters as a barcode.
